(19) United States
(12) Patent Application Publication
(10) Pub. No.: US 2010/0096894 A1
(43) Pub. Date: Apr. 22, 2010

(54) Shock absorbing device and chair

(75) Inventor: Zenroh Fukai, Tokyo (JP)

Correspondence Address: RABIN & Berdo, PC, 1101 14TH STREET, NW, SUITE 500, WASHINGTON, DC, 20005, US

(73) Assignee: OKI ELECTRIC INDUSTRY CO., LTD., Tokyo (JP)

(21) Appl. No.: 12/461,669

(22) Filed: Aug. 20, 2009

(30) Foreign Application Priority Data
Oct. 20, 2008 (JP) 2008-269720

(51) Int. Cl. A47C 1/024; F16F 1/06

(52) U.S. Cl. 297/300.5; 267/178

(57) ABSTRACT

A shock absorbing device is provided that includes a cylindrical damper, a compression coil spring disposed around the damper having an axis substantially in line with the axis of the damper, and a cylindrical spring guide disposed around the compression coil spring so as to cover the compression coil spring.

### CROSS-REFERENCE TO RELATED APPLICATION

This application is based on and claims priority under 35 USC 119 from Japanese Patent Application No. 2008-269720 filed on Oct. 20, 2008, the disclosure of which is incorporated by reference herein.

### BACKGROUND

1. Technical Field

The present invention relates to a shock absorbing device and a chair provided with the shock absorbing device.

2. Related Art

Conventionally, there has been proposed a technique related to coil springs, which provides a wave-coil spring that can be easily manufactured and can maintain good load bearing by preventing slipping (buckling) in the radial direction (see Japanese patent application Laid-Open (JP-A) No. 2007-321832, Abstract). In this technique, a belt-like coil material is fabricated into a wave shape having a convex part A and a concave part B and wound into a spiral shape to form a spring body 1. A concave part 12 whose width is smaller than that of the concave part B is disposed near a top portion of the convex part A. Further, when the spring body 1 contracts along the axial direction due to a compression load applied thereto, a bottom part 10 opposing the concave part B on the n+1st winding level is configured such that it is inserted into the concave part 12 formed on the nth winding level, where n is a natural number.

There has also been proposed a technique related to a shock absorbing device, which provides a shock absorbing mechanism functioning both as a spring and a damper (see JP-A No. 2002-61693, Abstract). In this technique, an elastic body 2, 31 is accommodated inside a stretch coil spring 2. The amount by which the elastic body protrudes out of the spring wire material changes in accordance with the stretching and compressing action of the spring so that the elastic resistance of the elastic body reduces the stretching and compressing action of the spring.

Further, page 72 of “Spring design” 2nd ed. 1978, ISBN978-4-621-02357-8, states that a buckling of a spring occurs when the vertical to horizontal ratio (free height/average coil radius) of the spring exceeds a predetermined value.

In the above-mentioned technique disclosed in the JP-A No. 2007-321832, although the buckling of the coil spring can be prevented, a special fabrication process must be applied to the spring. Further, if a user is able to touch the coil spring, the user's hand or the like may be caught between the coil springs.

Although the above-mentioned technique disclosed in JP-A No. 2002-61693 provides a shock absorbing device functioning both as a spring and a damper, due to the use of a tension coil spring, it cannot be used in situations or environments in which buckling may occur.

Therefore, a shock absorbing device with a high margin of safety and whose coil spring does not buckle is desired.

### SUMMARY

In accordance with an aspect of the present invention, there is provided a shock absorbing device including a cylindrical damper, a compression coil spring disposed around the damper so as to have an axis substantially in line with the axis of the damper, and a cylindrical spring guide covering the circumference of the compression spring.

In accordance with the aspect of the present inventions since a shock absorbing device includes the cylindrical spring guide covering the circumference of the compression spring, buckling of the coil spring can be prevented. Further, since the spring guide functions as a cover for the coil spring, a user can be prevented from touching the coil spring, and as a result the safety is increased.

### BRIEF DESCRIPTION OF THE DRAWINGS

Exemplary embodiments of the present invention will be described in detail based on the following figures, wherein:

FIGS. 1A and 1B are transparent perspective views of the shock absorbing device 100 relating to a first exemplary embodiment;

FIG. 2 is an exploded perspective view showing the shock absorbing device 100 of FIGS. 1A and 1B exploded into components;

FIGS. 3A and 3B are transparent perspective views of the shock absorbing device 100 relating to a second exemplary embodiment;

FIGS. 4A and 4B are transparent perspective views of the shock absorbing device 100 relating to a third exemplary embodiment;

FIGS. 5A and 5B are perspective views of the shock absorbing device 100 relating to a fifth exemplary embodiment;

FIGS. 6A and 6B are perspective views of the shock absorbing device 100 relating to a sixth exemplary embodiment;

FIG. 7 is a schematic side view showing the structure of the chair 400 relating to a ninth exemplary embodiment;

FIGS. 8A, 8B and 8C are drawings showing the changes in each of the parts when the user sits on the seat surface portion 301 and rests against the back surface portion 302.

### DETAILED DESCRIPTION OF THE INVENTION

### First Exemplary Embodiment

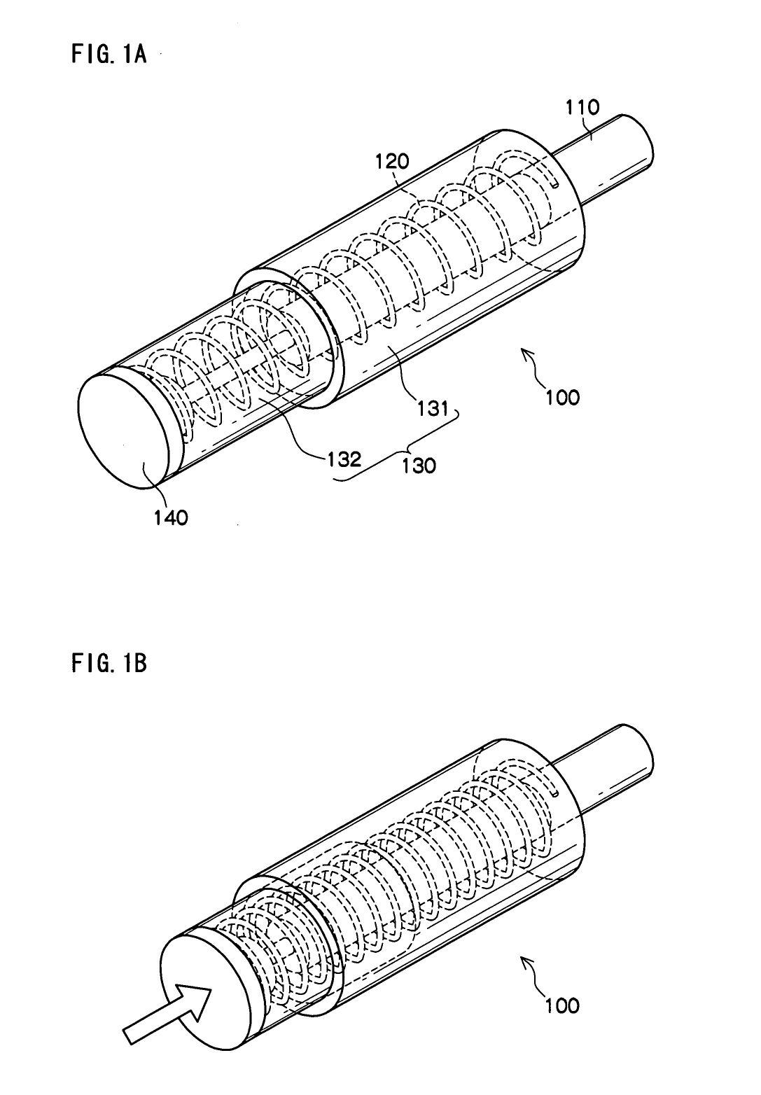

FIGS. 1A and 1B are transparent perspective views of the shock absorbing device 100 relating to the first exemplary embodiment. FIG. 1A is a perspective view before the shock absorbing device 100 is compressed. FIG. 1B is a perspective view when the shock absorbing device 100 is compressed. The shock absorbing device 100 includes a damper 110, a coil spring 120, a spring guide 130, and a lid member 140.

The damper 110 includes a cylinder having a cylindrical shape, and a piston rod that slides along the axial direction thereof. A viscous fluid such as oil is encapsulated inside the cylinder and applies a viscous resistance to the piston rod in order to resist a stroke.

The damper 110 may be configured by a shock absorber such as an oil damper.

The coil spring 120 is a compression coil spring that is disposed around the damper 110 so as to have an axis substantially in line with the axis of the damper 110.

The spring guide 130 is formed by a first spring guide 131 and a second spring guide 132 both of which are cylindrical. The first spring guide 131 is disposed around the coil spring 120 so as to cover approximately half of the coil spring 120 along the length direction. The second spring guide 132 has a slightly smaller radius than the first spring guide 131, and is disposed around the coil spring 120 so as to cover the remaining half of the coil spring 120. The second spring guide 132 is placed along the same axis as that of the first spring guide 131, slides in conjunction with the sliding of the piston rod of the damper 110 and is accommodated inside the first spring guide 131.

The lid member 140 seals one end of the second spring guide 132.

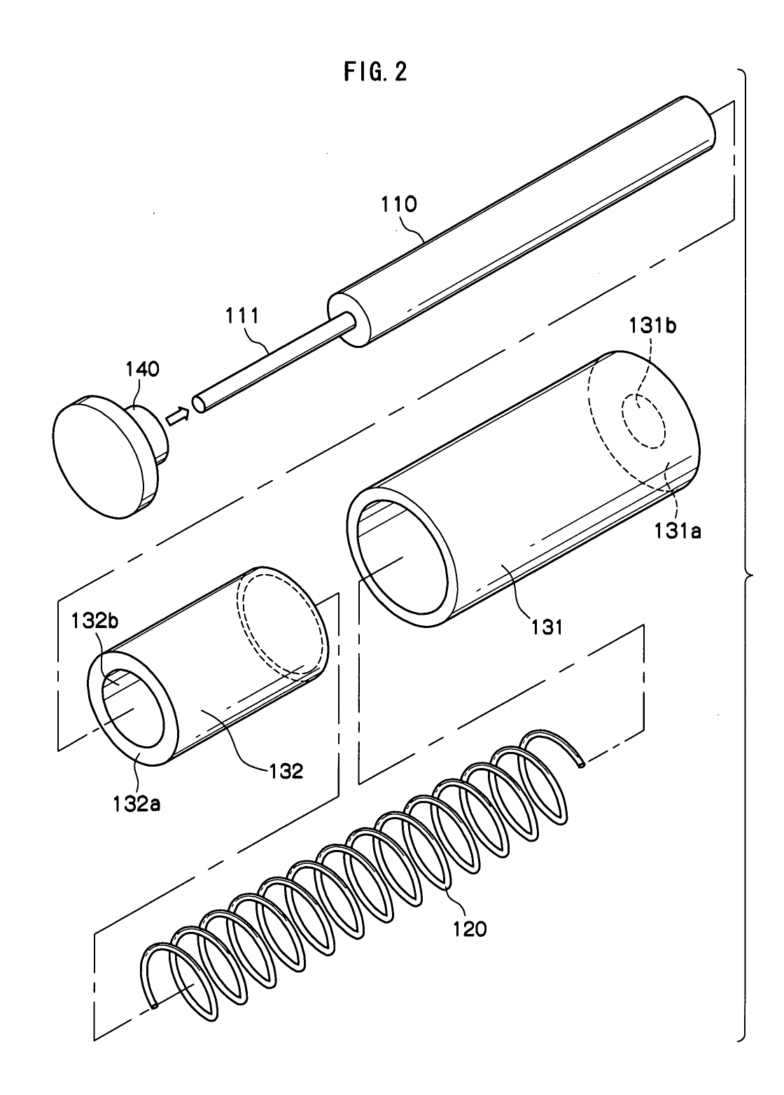

One end of the coil spring 120 is in contact with a bottom surface 131a of the first spring guide 131, which is described later with reference to FIG. 2, so that it is restrained from stretching in the same direction.

FIG. 2 is an exploded perspective view showing the shock absorbing device 100 exploded into components. Hereinafter, each of the components will be described.

The lid member 140 includes a double cylindrical column having two different radii. The portion with the smaller radius of the lid member 140 has a thickness that allows an insertion thereof into an insertion hole 132b which is described later. The portion with the larger radius of the lid member 140 contacts with the bottom surface 132a, which is described later, in order to seal the one end of the second spring guide 132.

The lid member 140 is fixed onto a piston rod 111 of the damper 110 by a screw portion that can be screwed into the piston rod 111.

The first spring guide 131 is cylindrical and has a bottom surface 131a at the one end thereof.

When the coil spring 120 is accommodated in the first spring guide 131, the one end of the coil spring 120 contacts the bottom surface 131a. Due thereto, the stretching of the one end of the coil spring 120 is restrained. Further, the bottom surface 131a has an insertion hole 131b for inserting the damper 110 thereinto.

The second spring guide 132 is cylindrical and has a bottom surface 132a at the one end thereof.

When the coil spring 120 is accommodated in the second spring guide 132, the other end of the coil spring 120 is in contact with the bottom surface 132a. Due thereto, the stretching of the other end of the coil spring 120 is restrained. Further, the bottom surface 132a has an insertion hole 132b for inserting the lid member 140 thereinto.

The bottom surface 131a and the bottom surface 132a function both as a lid member of the spring guide 130 and as a means for applying a pre-tension to the coil spring 120 by contacting with the coil spring 120 as described below.

The assembly sequence by which the parts shown in FIG. 2 are assembled into the state as shown in FIG. 1 is as follows.

1) The damper 110 is inserted into the insertion hole 131b.

2) The coil spring 120 is inserted through the damper 110 from the side of the piston rod and the end thereof is made to contact with the bottom surface 131a.

3) The second guide 132 is placed so as to cover the coil spring 120.

4) The lid member 140 is fixed onto the piston rod.

In the above, the structure of the shock absorbing device 100 relating to the first exemplary embodiment is described.

Subsequently, the effect attained by each of the components is explained.

(1) Prevention of the Buckling of the Coil Spring 120

The first spring guide 131 and the second spring guide 132 cover the coil spring 120 by accommodating the coil spring 120 thereinside. Therefore, the displacement of the coil spring 120 is constrained so as to prevent buckling.

The coil spring 120 does not require any special fabrication process. Further, the first spring guide 131 and the second spring guide 132 are formed by simple shapes. Therefore, the buckling of the coil spring 120 can be prevented with low cost.

Further, by preventing the buckling, the elastic effect of the coil spring 120 is made sufficiently manifest.

(2) The Safety of the Coil Spring 120

When the coil spring 120 is accommodated inside the first spring guide 131 and the second spring guide 132, the coil spring 120 is not exposed to the outside. Due thereto, the user may not touch the coil spring 120.

Therefore, there is no concern that the user will be injured by having his/her hands caught in the coil spring 120. Thus, the safety of the shock absorbing device 100 is increased.

(3) Pre-Tension of the Coil Spring 120

When the coil spring 120 is accommodated inside the first spring guide 131 and the second spring guide 132, the ends of the coil spring 120 are sandwiched between the bottom surface 131a and the bottom surface 132a respectively.

Thus, if the lid member 140 and the piston rod 111 are fixed by a screw portion, by adjusting the amount by which the screw portion is screwed, the position at which the lid member 140 is fixed can be adjusted. If the lid member 140 is fixed at a position near the damper 110, the bottom surface 132a also comes closer to the damper 110, and as the result, the coil spring 120 is compressed further.

Thus, the initial compression state of the coil spring 120 is determined according to the position of the lid member 140. Due thereto, a predetermined pre-tension can be applied to the coil spring 120.

Note that in the first exemplary embodiment, the damper 110 is directly inserted into the insertion hole 131b. However, in order to increase the safety of the damper 110, the damper 110 may be inserted into the first spring guide 131 through an appropriate guiding material. The same applies to the embodiments described below.

As described above, according to the first exemplary embodiment, the coil spring 120 is accommodated inside the spring guide 130. Due thereto, buckling of the coil spring 120 is prevented and safety can be increased.

Further, in the first exemplary embodiment, the bottom surfaces 131a and 132a, which are means for applying pre-tension to the coil spring 120, are formed integrally with the spring guide 130.

Due thereto, the structure of the shock absorbing device 100 is simplified, the number of components are decreased and costs can be reduced.

### Second Exemplary Embodiment

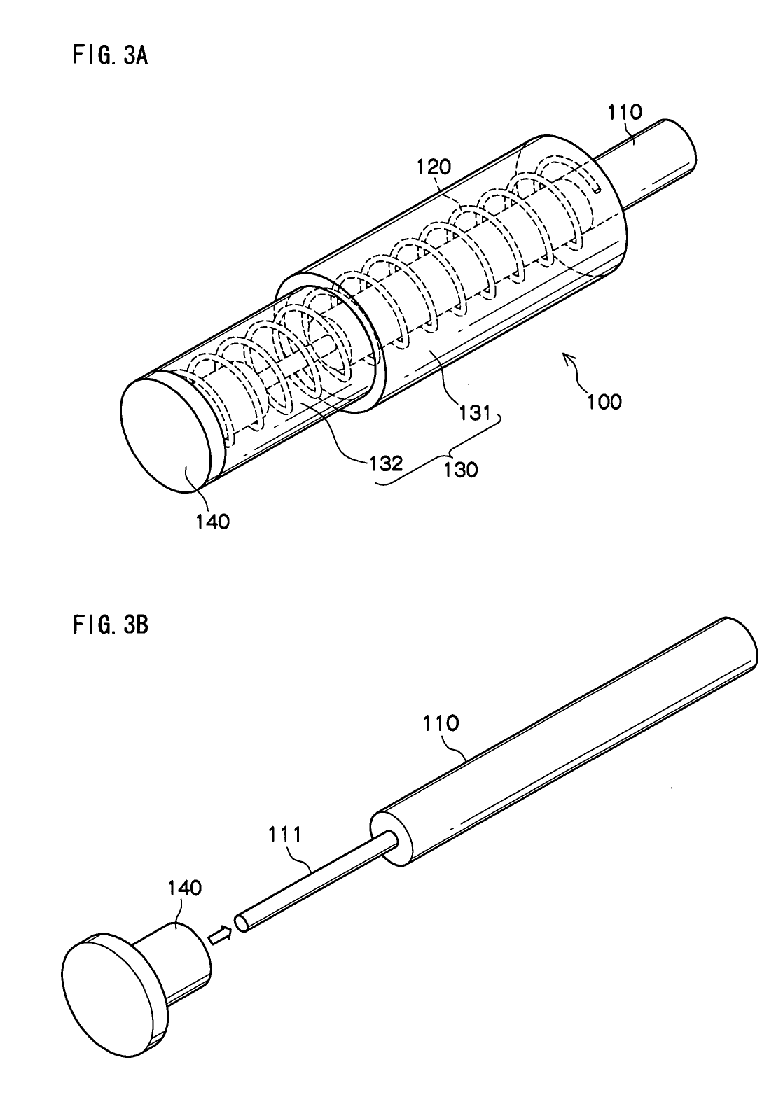

FIGS. 3A and 3B are transparent perspective views of the shock absorbing device 100 relating to the second exemplary embodiment. FIG. 3A is a perspective view before the shock absorbing device 100 is compressed and FIG. 3B is an exploded perspective view of the damper 110 and the lid member 140.

In the second exemplary embodiment, the lid member 140 has a predetermined thickness along the axis of the damper 110. This thickness is larger than the thickness of the lid member 140 of the first exemplary embodiment. Other structures are the same as the first exemplary embodiment.

The lid member 140 of the first exemplary embodiment has a thickness that allows an insertion thereof into the insertion hole 132b. However, the lid member 140 of the second exemplary embodiment has a thickness that allows an insertion thereof into the coil spring 120 only to a predetermined depth when the coil spring 120 is accommodated inside the spring guide 130.

In other words, the lid member 140 of the second exemplary embodiment functions as a guide that guides the stretching direction of the one end of the coil spring 120. Therefore, the coil spring 120 is guided by the spring guide 130 from the outside as well as by the lid member 140 from the inside. Due thereto, the stretching direction of the coil spring 120 is ensured to be a straight line so that buckling can be prevented.

Further, the effect of the buckling prevention is increased by only thickening the lid member 140. Thus, the effect of the buckling prevention is attained by a simple structure.

### Third Exemplary Embodiment

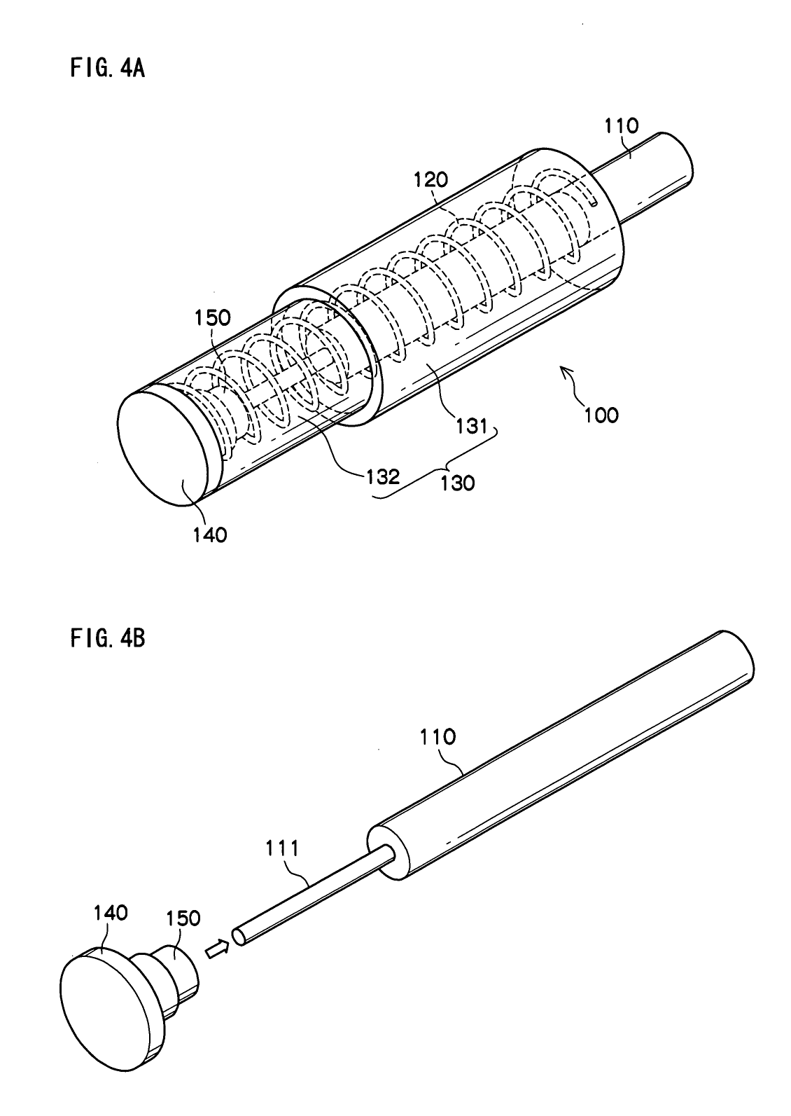

FIGS. 4A and 4B are transparent perspective views of the shock absorbing device 100 relating to the third exemplary embodiment. FIG. 4A is a perspective view before the shock absorbing device 100 is compressed, and FIG. 4B is an exploded perspective view of the damper 110 and the lid member 140.

The shock absorbing device 100 of the third exemplary embodiment further includes an elastic shock absorbing member 150 in addition to the structures explained in the first exemplary embodiment. The other structures are the same as in the first exemplary embodiment.

The elastic shock absorbing member 150 is formed, for example, by a cylindrical rubber and is placed inside (side at which it contacts with the coil spring 120) of the lid member 140.

The elastic shock absorbing member 150 prevents the lid member 140 and the damper 110 from directly coming in contact with each other and damaging each other when the coil spring 120 is compressed.

Further, when the lid member 140 and the damper 110 comes in direct contact with each other, metallic sound may occur that is unpleasant to the user's ears. The elastic shock absorbing member 150 functions to prevent such sound.

The radius of the elastic shock absorbing member 150 can be made substantially equal to the smaller radius of the lid member 140 or can be made smaller than this radius.

If the radius of the elastic shock absorbing member 150 is made substantially equal to the smaller radius of the lid member 140, the elastic shock absorbing member 150 functions as a guide that guides the coil spring 120 in the stretching direction thereof in the manner similar to the lid member 140 explained in the second exemplary embodiment.

If the lid member 140 itself is structured by an elastic member, it functions similarly to the elastic shock absorbing member 150. However, the lid member 140 is a portion which is directly pushed. Therefore, when there is a concern regarding strength, the elastic shock absorbing member 150 as in the third exemplary embodiment can be provided as an additional component.

Note that the third exemplary embodiment shows a structure in which the elastic shock absorbing member 150 is provided in addition to the structure of the first exemplary embodiment. However, the elastic shock absorbing member 150 may be provided in addition to the structure of the second exemplary embodiment.

As explained above, the third exemplary embodiment prevents the damper 110 and the lid member 140 from coming into contact and damaging each other, and also avoids an unpleasant noise from arising.

### Fourth Exemplary Embodiment

The damper 110 may be structured by a shock absorber in which viscous fluid such as oil is encapsulated therein. However, due to air being mixed into the damper, the piston rod may make an operation noise as it slides. Depending on the environment in which the shock absorbing device 100 is used, such a noise may become irritating to the user.

As a means to prevent the transmission of sound, the hermetic seal of the spring guide 130 is enhanced by substantially hermetically sealing the damper 110 and the coil spring 120. The other structures are the same as in the first through third exemplary embodiments.

Due thereto, the operation noise of the damper 110 does not readily escape to the outside of the shock absorbing device 100. Consequently, the user does not hear unpleasant operation noise.

Further, by forming the spring guide 130 by a material with high sound insulation or sound attenuation effect, the operation noise due to the damper 110 may further be suppressed.

As described above, according to the fourth exemplary embodiment, the user does not hear unpleasant operation noise of the damper 110. Therefore, the usability of the shock absorbing device 100 is enhanced. The same effect can be achieved for a structure provided with the shock absorbing device 100.

### Fifth Exemplary Embodiment

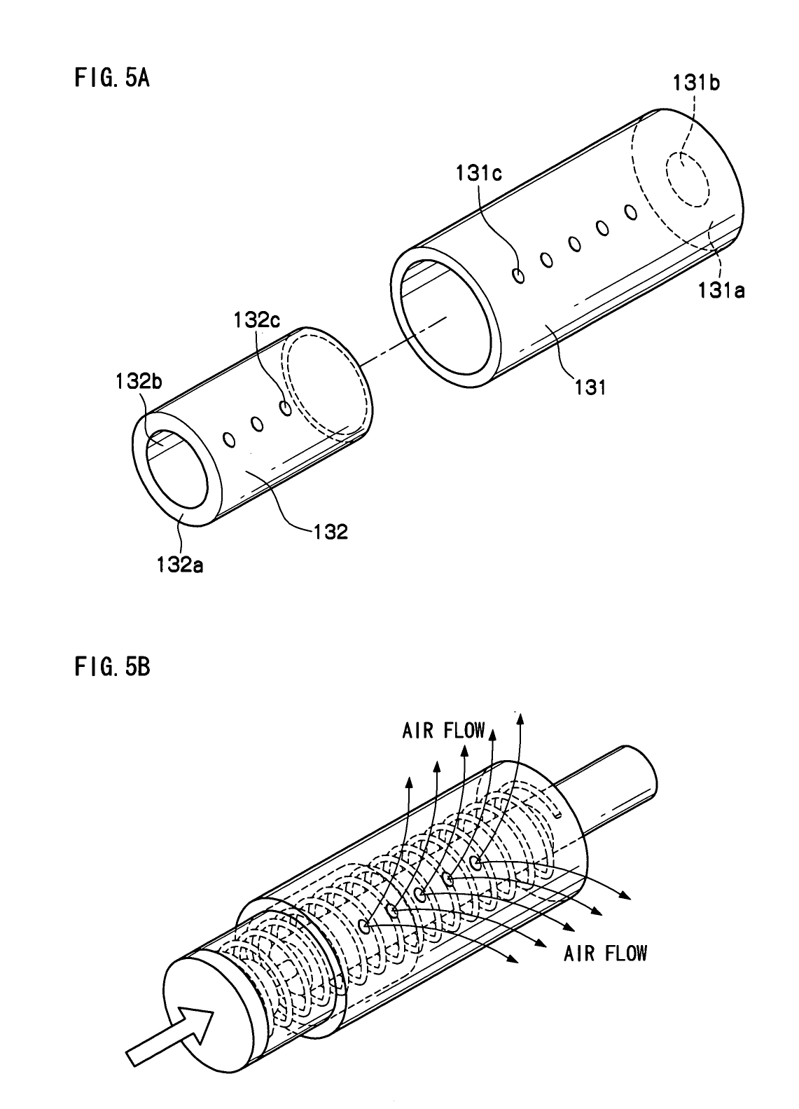

FIGS. 5A and 5B are perspective views of the shock absorbing device 100 relating to the fifth exemplary embodiment. FIG. 5A is an exploded perspective view of the spring guide 130 of the fifth exemplary embodiment. FIG. 5B is a perspective view when the shock absorbing device 100 is compressed. The structure of the components other than that of the spring guide 130 are the same as in the exemplary embodiments 1 through 4.

In the fifth exemplary embodiment, each of the first spring guide 131 and the second spring guide 132 includes on the side surfaces thereof exhaust openings 131c and 132c. When the coil spring 120 is compressed, the air inside the spring guide 130 is exhausted out of the exhaust openings 131c and 132c. Due to the sound generated by the exhausted air, the operation noise of the damper 110 is canceled so that the user does not hear an unpleasant operation noise.

Further, FIGS. 5A and 5B show the spring guide 130 with exhaust openings formed on the side surfaces thereof. Therefore, the number of exhaust openings that exhaust air decreases as the coil spring 120 is compressed and the amount of overlap between the spring guides 131 and 132 increases.

Due thereto, the spring guide 130 functions as an air damper that stiffens as the compression proceeds. Further, as the number of exhaust openings that exhaust air decreases, the sound generated by the exhausted air changes.

The position, number and shapes of the exhaust openings 131c and 131c depend on the shape and size of the spring guide 130 and the magnitude and the frequency of the operation noise of the damper 110. Therefore, an optimal structure of the exhaust opening 131c and 132c may be sought.

Note that in FIGS. 5A and 5B, the exhaust openings are formed on both of the first spring guide 131 and the second spring guide 132. However, the exhaust openings may be formed only on one of the first spring guide 131 and the second spring guide 132. Further, the exhaust openings 131c through 132c need not be formed on side surfaces of the first spring guide 131 and the second spring guide 131, and may be formed on the bottom surfaces 131a through 132a.

As described above, the sound generated by air from the exhaust openings 131c and 132c cancels the operation noise of the damper 110.

Therefore, the effect as explained in the fourth exemplary embodiment can be enhanced.

### Sixth Exemplary Embodiment

In the first through fifth exemplary embodiments described above, when the damper 110 is compressed from the side of the piston rod 111, the one end of the coil spring 120 pushes against the bottom surface 131a of the first spring guide 131 in both directions. In order to compress the coil spring 120, the bottom surface 131a needs to be supported from the opposite side. The sixth exemplary embodiment explains one structure that provides such a supporting means.

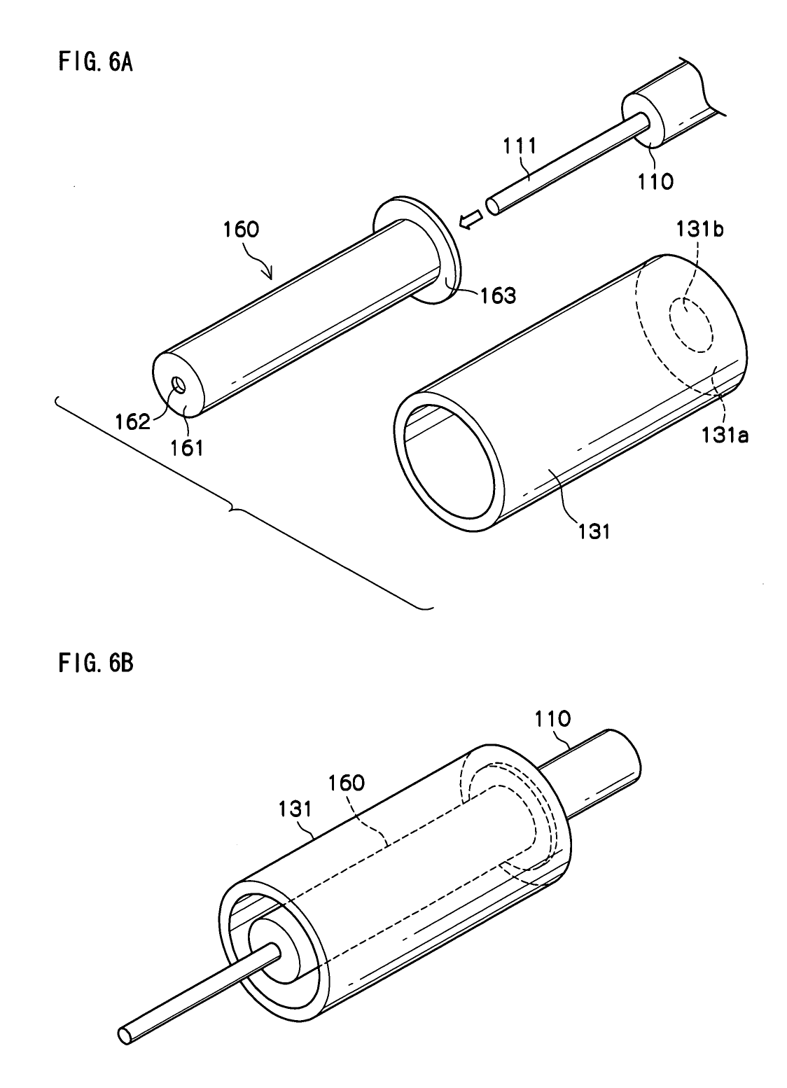

FIGS. 6A and 6B are perspective views of the shock absorbing device 100 relating to the sixth exemplary embodiment. FIG. 6A is an exploded perspective view of the components of the shock absorbing device 100. FIG. 6B is a perspective view showing the components of the shock absorbing device 100 during assembly. Note that some components such as coil spring 120 are omitted.

The shock absorbing device 100 relating to the sixth exemplary embodiment includes the third spring guide 160 in addition to the structures as explained in the exemplary embodiments 1 through 5.

The third spring guide 160 has a cylindrical body and, at the one end thereof, a bottom surface 161 is disposed. Further, at the other end thereof, a flange portion 163 is disposed.

An insertion hole 162 for inserting the piston rod 111 therethrough is formed on the bottom surface 161.

The radius of the flange portion 163 is larger than the radius of the bottom surface 161 or the size of the insertion hole 131b of the first spring guide 131.

Each component is assembled as follows.

1) The damper 110 is inserted with the piston rod 111 headfirst from the side of the flange portion 163 of the third spring guide 160.

2) The piston rod 111 is inserted into the insertion hole 162.

3) The third spring guide 160 with the damper 110 inserted therein is inserted into the insertion hole 131b of the first spring guide 131.

Next, the function of the third spring guide 160 is explained.

When the damper 110 is compressed from the side of the piston rod 111, the one end of the coil spring 120 pushes the bottom surface 131a of the first spring guide 131 in the same direction.

At this point, since the opposite side of the bottom surface 131a is supported by the flange portion 163, the bottom surface 131a constrains the one end of the coil spring 120 so that the coil spring 120 is compressed.

Further, in the state as assembled according to FIG. 6B, the third spring guide 160 functions as a protective guard for the side surface of the damper 110.

In other words, the third spring guide 160 protects the coil spring 120 from coming in direct contact with the damper 110. Thus, such a structure is advantageous in a case in which the side wall of the damper 110 is thin and does not have enough strength.

Note that besides using the third spring guide 160 as a means to support the bottom surface 131a from the opposite side, a component corresponding to the flange portion 163 may be disposed on the damper 110 or on the member at which the shock absorbing device 100 is disposed.

As explained above, in the sixth exemplary embodiment, the flange portion 163 included in the third spring guide 160 is used as a stopper that supports the bottom surface 131a.

Further, the third spring guide 160 protects the side surface of the damper 110 and guides the stretching of the coil spring 120 from thereinside in place of the damper 110.

Note also that the structure as explained in the sixth exemplary embodiment may be applied to other embodiments.

### Seventh Exemplary Embodiment

The vertical-to-horizontal ratio (=free height/average coil radius) of the coil spring 120 as explained in the first through sixth exemplary embodiments may be set arbitrarily. However, in regards to the prevention of the buckling of the coil spring 120, use of the spring guide 130 and the like is particularly useful when the coil spring 120 has a vertical-to-horizontal ratio at which buckling occur.

According to the page 72 of “Spring design” 2nd ed. 1978, ISBN978-4-621-02357-8, buckling occur when the vertical-to-horizontal ratio exceeds 5.3.

Thus, the first through sixth exemplary embodiments may be used in a situation under which the vertical-to-horizontal ratio of the coil spring 120 is greater than 5.3.

### Eighth Exemplary Embodiment

The shock absorbing device 100 according to the first through seventh exemplary embodiments described above may be disposed on other structures. In regards to the safety and the sound silencing effect of the shock absorbing device 100, the shock absorbing device 100 may be disposed on the structure in which the user may touch the shock absorbing device 100.

For instance, the shock absorbing device 100 according to the first through sixth exemplary embodiments may be provided on a chair as a shock absorber.

A chair contains many exposed components, and as such, it is likely that the user may touch these components. Due thereto, the coil spring 120 accommodated inside the spring guide 130 is desirable from a standpoint of safety.

Further, since chairs are used in close contact with the user, the operation noise of the shock absorbing device 100 can readily be heard by the user. In such a case, the structure according to the fourth exemplary embodiment through 5 that silences the operation noise of the damper 110 may be used.

### Ninth Exemplary Embodiment

In the ninth exemplary embodiment, a detailed structure of a chair with the shock absorbing device 100 relating to the first through seventh exemplary embodiments provided therein is explained.

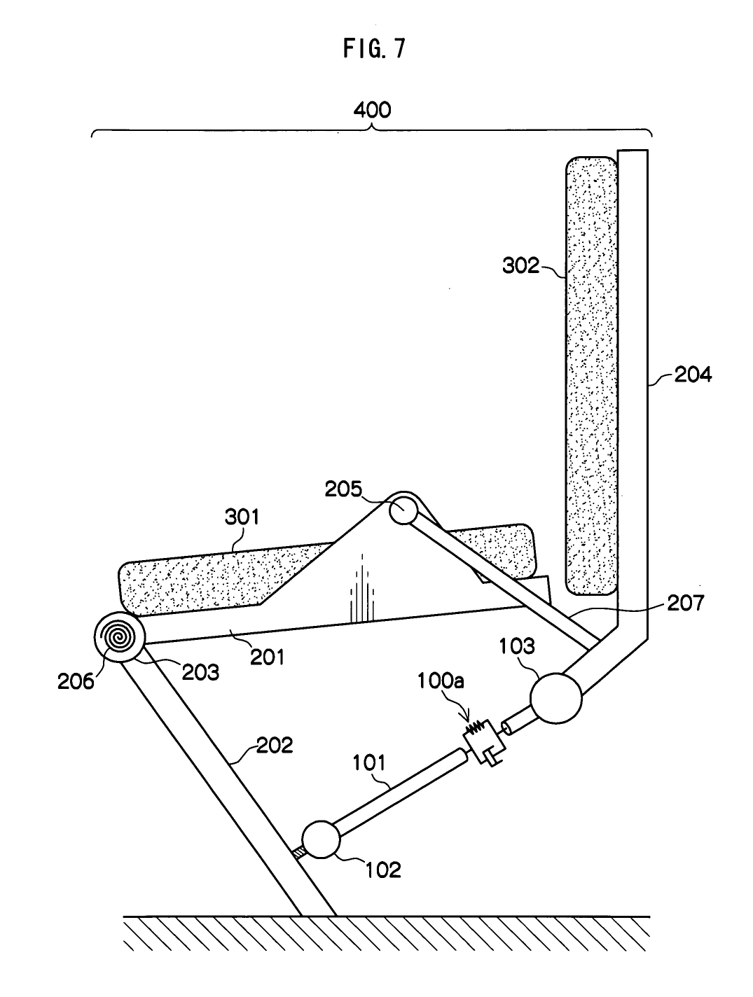

FIG. 7 is a schematic side view showing the structure of a chair 400 relating to the ninth exemplary embodiment. Here, only portions that are necessary for explaining the structure of the chair 400 are given. Hereinafter, the overall structure of the chair 400 will be described first. Then, details of the link mechanism of the chair 400 will be explained.

The chair 400 has a seat surface portion 301 and a back surface portion 302.

The seat surface portion 301 is fixed on a first link 201 that will be described later.

The back surface portion 302 is fixed on a second link 204 that will be described later.

The first link 201 supports the seat surface portion 301 from below, and is connected to a base portion 202 that will be described later via a first joint portion 203.

Further, the portion of the first link 201 that corresponds to the side surface of a user who is seated on the seat surface portion 301 rises upwardly. This upwardly-rising portion is connected to the second link 204 via a fourth link 207 that will be described later.

The base portion 202 supports the self-weight of the chair 400 and the body weight of the user who is seated on the seat surface portion 301.

The first joint portion 203 is structured by, for example, a hinge joint, and rotatably connects the first link 201 and the base portion 202. The first joint portion 203 has an elastic resistance unit 206, such as a rotary spring or the like, for imparting elastic force. The elastic resistance unit 206 may be structured by, for example, a torsion spring or the like.

The second link 204 is disposed at the rear of the back surface portion 302, and, via the back surface portion 302 and from the rear, supports the back of the user who is seated on the seat surface portion 301.

The second link 204 is connected, via the fourth link 207 that will be described later, to the first link 201 at a position corresponding to the side surface of the user. Moreover, the second link 204 is connected to a third link 101 that will be described later via a third joint portion 103 that will be described later.

The fourth link 207 is fixedly connected to the second link 204.

The fourth link 207 is connected, via the fourth joint portion 205 that will be described later, to the first link 201.

The fourth joint portion 205 is structured by a hinge joint for example, and rotatably connects the first link 201 and the fourth link 207.

Due to the structure of the above-described first link 201 and the fourth link 207, the fourth joint portion 205 is disposed at a position that is apart, by a predetermined distance forward, from the second link 204 and the back surface portion 302.

The position of the fourth joint portion 205 approximately corresponds to the position of the hip joint of the user when the user is seated on the seat surface portion 301.

A second joint portion 102 is connected, via an appropriate link mechanism, to the above-described base portion 202.

A third link 101 is rotatably connected, via a third joint portion 103 described later, to the above-described second link 204.

The third joint portion 103 is structured, for example, by a hinge joint, and connects the second link 204 and the third link 101 rotatably.

The third link 101 is disposed beneath the first link 201. One end of the third link 101 is connected, via the third joint portion 103, to the second link 204. The other end of the third link 101 is connected to the second joint portion 102. Further, due to the repelling elastic force imparted by a viscoelastic resistance unit 100a described below, the third link 101 functions to push the second link 204 rightward (in the direction of the back surface of the user) in FIG. 7.

The viscoelastic resistance unit 100a is structured by a shock absorbing device 100 explained in one of the exemplary embodiments 1 through 7. For instance, an appropriate fixing member may be disposed on the bottom surface of the lid member 140 and the damper 110 so that the viscoelastic resistance unit 100a is formed integrally with the third link 101.

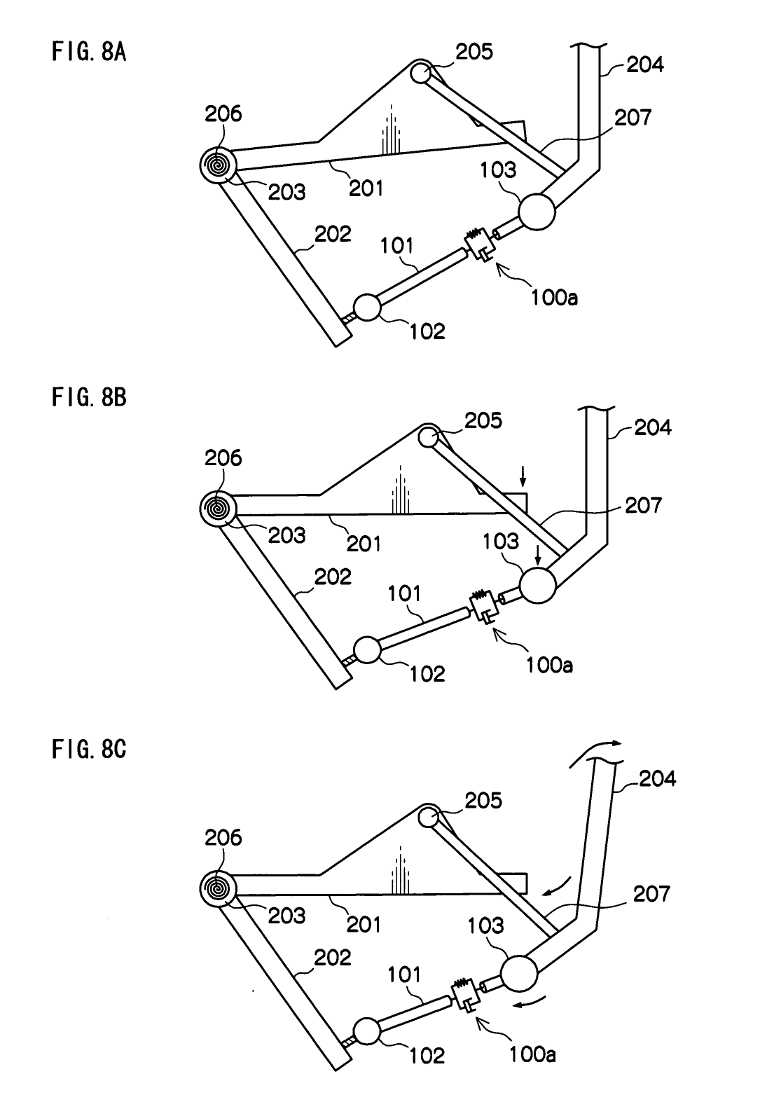

The viscoelastic resistance unit 100a imparts repelling elastic force to the third link 101 and functions to push the second link 204 rightward in FIG. 7. The detailed operation is explained with reference to FIGS. 8A through 8C.

The link mechanism of the chair 400 has been described above.

Next, operation of the respective portions when a user sits on the seat surface portion 301 of the chair 400 will be described.

FIGS. 8A through 8C are drawings showing changes in the respective portions at a time when a user sits on the seat surface portion 301 and rests against the back surface portion 302. Here, among the respective portions shown in FIG. 7, only the portions that are needed for explanation are selectively illustrated.

FIG. 8A shows a state before the user sits on the seat surface portion 301. The state shown in FIG. 8A is similar to the state of the respective portion shown in FIG. 7.

FIG. 8B shows a state when the user sits on the seat surface portion 301, and before he/she rests against the back surface portion 302. The processes from FIG. 8A to FIG. 8B will be described hereinafter.

1) When the user sits on the seat surface portion 301, the first link 201 rotates with the first joint portion 203 being the fulcrum, so as to sink in.

2) As the first link 201 sinks in, the second link 204 and the third joint portion 103 are pushed downward by the fourth link 207.

3) Accompanying the third joint portion 103 being pushed downward, the third link 101 rotates clockwise seen from the front surface of FIG. 8A through 8C with the second joint portion 102 being the fulcrum. Further, accompanying this, the second joint portion 102 also rotates clockwise.

4) As the first link 201 sinks in, the angle between the first link 201 and the base portion 202 becomes smaller. The elastic resistance unit 206 imparts an elastic force in the direction that resists this action.

5) At the point in time when the weight of the user and the elastic force are in equilibrium, the rotation of the first link 201 and sinking of the seat surface portion 301 stops.

6) At this point in time, the user's seating posture is determined. Therefore, compared to before-seating, the angle between the first link 201 and the base portion 202 is narrowed and gives an effect of the back surface portion 302 approaching the user's back and automatically fitting thereto. Namely, merely by sitting on the seat surface portion 301, the user obtains an optimal seated posture.

The operation of the respective portions at the time when the user sits on the seat surface portion 301 of the chair 400 have been described above.

FIG. 8C shows a state at the time when the user rests against the back surface portion 302, after having sat on the seat surface portion 301. Hereinafter, the processes from FIG. 8B to FIG. 8C will be described.

7) When the user rests against the back surface portion 302, the second link 204 is, with the fourth joint portion 205 being the center of rotation, supported by the fourth link 207 and rotates clockwise as shown from the front surface of FIG. 8C.

8) When the second link 204 rotates clockwise, the third joint portion 103 is pushed substantially leftward (in the direction of the front surface of the user) as seen from the front surface of FIG. 8C.

9) Accompanying this, the viscoelastic resistance unit 100a is pushed, and repelling elastic force toward the right in FIG. 8C (in the direction of the back surface of the user) is generated.

10) At the point in time when the force at which the user rests against the back surface portion 302 and this repelling elastic force are in equilibrium, the tilting of the second link 204 stops, and the back-resting posture of the user is determined.

The operations of the respective portions at the time when the user sits on the seat surface portion 301 of the chair 400 have been described above.

As described above, the chair 400 relating to the ninth exemplary embodiment includes the viscoelastic resistance unit 100a structured by the shock absorbing device 100 relating to the first through seventh exemplary embodiments.

Due thereto, the elastic capability of the viscoelastic resistance unit 100a does not decrease due to buckling and margin of safety can be enhanced. Further, by adapting the structures explained in exemplary embodiments 4 through 5, the user does not hear unpleasant operation noise of the damper 110. Thus, usability of the chair 400 is enhanced.

Further, as explained in FIGS. 8B and 8C the seat surface portion 301 and the back surface portion 302 of the chair 400 relating to the ninth exemplary embodiment change their configuration as the user sits. Therefore, the user may maintain his/her optimal posture at all times.

Further, by adjusting the coefficients of elasticity of the elastic resistance unit 206 and the viscoelastic resistance unit 100a that are provided at the chair 400, the strengths of forces needed when the seat surface portion 301 is sunk-in and the back surface portion 302 is inclined can be adjusted.

Similarly, by adjusting the coefficient of viscosity of the viscoelastic resistance unit 100a, the smoothness with which the back surface portion 302 tilts can be adjusted.

Due thereto, a sitting feeling and the usability of the chair 400 can be adjusted arbitrarily.

Further, in the chair 400 relating to the ninth exemplary embodiment, the second link 204 rotates around the fourth joint portion 205 as the center of rotation.

The fourth joint portion 205 is substantially positioned at the hip joint of the user sitting in the seat surface portion 301 Therefore, the second link 204 and the back surface portion 302 may rotate around the user's hip joint as the center of rotation.

Due thereto, the rotation of the back surface portion 302 can be adjusted to the body structure and provide a seating comfort to the user.

What is claimed is:

1. A shock absorbing device comprising:
a cylindrical damper;
a compression coil spring disposed around the damper having an axis substantially in line with the axis of the damper;
a cylindrical spring guide disposed around the compression coil spring so as to cover the compression coil spring, a first end of the spring guide being provided with a lid portion that contacts the corresponding end of the compression coil spring; and
a lid member that seals a second end of the spring guide, the lid member being disposed at a position at which it applies a pre-tension to the compression coil spring when the second end of the spring guide is sealed.

2. The shock absorbing device of claim 1, wherein the lid member has a predetermined thickness along the axis direction of the compression coil spring, and is fitted to a predetermined depth at the inside of the compression coil spring when the second end of the spring guide is sealed, so as to constrain the direction of extension and compression of the compression coil spring.

3. The shock absorbing device of claim 1, further comprising an elastic shock absorbing member inside of the lid member.

4. The shock absorbing device of claim 1, further comprising a flanged spring guide that guides the compression coil spring from thereinside, a first end of the flanged spring guide being provided with a bottom surface having an insertion hole for allowing an insertion of the cylindrical damper therethrough and a second end of the flanged spring guide being provided with a flange portion for fixing the coil spring inside the spring guide, the flange portion having a radius larger than the radius of the bottom surface.

5. The shock absorbing device of claim 2, further comprising an elastic shock absorbing member inside of the lid member.

6. The shock absorbing device of claim 1, wherein
the spring guide prevents transmission of the sound generated by the damper by substantially hermetically sealing the compression coil spring.

7. The shock absorbing device of claim 6,
wherein the spring guide has expelling holes that expel air from inside the spring guide when the compression coil spring is compressed.

8. The shock absorbing device of claim 1,
wherein the vertical to horizontal ratio of the compression coil spring is substantially greater than 5.3.

9. A chair comprising the shock absorbing device of claim 1.

10. A chair comprising:
a base portion;
a seat surface portion;
a back surface portion;
a first link that supports the seat surface portion;
a second link that supports the back surface portion;
a third link that connects the second link and the base portion;
a first joint portion that connects the base portion and the first link rotatably;
a second joint portion that connects the base portion and the third link rotatably;
a third joint portion that connects the second link and the third link rotatably; and
a viscoelastic shock absorbing member comprising the shock absorbing device of claim 1 that imparts repelling elastic force and viscous resistance to the third link.
